(19) United States
(12) Patent Application Publication
(10) Pub. No.: US 2009/0268570 A1
(43) Pub. Date: Oct. 29, 2009

(54) Apparatus and method for changing speed of recording on optical recording medium during recording operation

(75) Inventors: Sung-ro Go, Gyeonggi-do (KR); Seung-un Yang, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/453,314

(22) Filed: May 6, 2009

Related U.S. Application Data
(63) Continuation of application No. 10/400,618, filed on Mar. 28, 2003.

(30) Foreign Application Priority Data
Apr. 17, 2002 (KR) 2002-20913

(51) Int. Cl. G11B 19/00

(52) U.S. Cl. 369/47.44; 714/758; G9B/19

(57) ABSTRACT

An apparatus for changing a recording speed of an optical recording medium by analyzing wobble signals in real time during a recording operation, includes a signal process unit which outputs a cyclic redundancy check (CRC) signal that checks for a generation of errors on the optical recording medium from absolute time in pregroove (ATIP) information output from the optical recording medium during the recording operation, and a speed control unit which changes the recording speed during the recording operation according to a comparison of the CRC signal output from the signal process unit with a reference value. In the apparatus, the recording speed is limited or lowered in response to a signal quality of a recording section being less than an acceptable level during the recording operation. Accordingly, buffer under run and defects of read-in start position and seek fail, which are generated during a ZCLV operation, are prevented. In addition, the apparatus detects errors in characteristics of wobble signals from low quality media, and changes the recording speed to improve the recording quality and readability of such discs after the recording operation.

### CROSS-REFERENCE TO RELATED APPLICATIONS

This application is a Continuation of Ser. No. 10/400,618, filed Mar. 28, 2003, now pending and claims the benefit of Korean Patent Application No. 2002-20913, filed Apr. 17, 2002 in the Korean Intellectual Property Office, the disclosure of which is incorporated herein by reference.

### BACKGROUND OF THE INVENTION

1. Field of the Invention

The present invention relates to the field of an optical recording, and more particularly, to an apparatus and a method of changing a speed of recording on an optical recording medium by analyzing wobble signals in real time during a recording operation thereof.

2. Description of the Related Art

Due to the improvements in the optical disc drive (ODD) technology, a recording speed of recording apparatuses has been increased greatly. However, the increase of the recording speed of the recording apparatuses lowers a recording quality and causes instability during a recording operation thereof. In addition, among the various different recording media manufactured by various different manufacturers, some media are of very low quality and when recorded thereon, deterioration of the recording quality becomes a serious problem. To prevent the deterioration of the recording quality, techniques to limit or forcibly lower the recording speed, in an environment where problems may occur, have been introduced and used in various ODDs.

The conventional techniques to limit or forcibly lower the recording speed can be divided into the following four types.

The first type includes methods of limiting the recording speed of an unknown disc by checking the maximum recording speed of the disc and comparing it to recording strategy data.

That is, where an unknown disc is inserted into a recording apparatus, the recording apparatus reads absolute time in pregroove (ATIP) information from the disc. Here, the ATIP information includes the manufacturer, the maximum recording speed, an optimum recording power, and a read-in start position of the disc. With reference to the ATIP information, where it is determined that the inserted disc is an unknown disc, does not support the maximum recording speed, or has a lower recording quality than the recording strategy database, the maximum recording speed may be limited.

The second type includes methods of limiting the recording speed of a disc lacking a recording power margin after an optimum power control (OPC) operation.

That is, a recording apparatus performs the OPC operation in a power calibration area (PCA) zone prior to a recording operation. Based on the result of the OPC operation, a recording power of the recording operation is determined. Here, where the recording power lacks a top margin based on a beta or gamma measurement value, the maximum recording speed is limited. In particular, in the case of a recordable compact disc (CD-R), the top margin of the recording power has to be secured to perform a running-OPC (R-OPC) operation, i.e., an OPC monitoring operation. Accordingly, where the disc lacks the top margin of the recording power, the recording speed is forcibly reduced.

The third type includes methods of limiting the recording speed after measuring a radial noise and deflection elements of a disc.

Here, the recording speed is determined by measuring a tracking error quality and [the] a focus error quality of a blank disc before a recording operation. In this case, a pickup is transferred to a predetermined section of the disc and tracking and focus levels are measured for one rotation of the disc. The characteristics of the radial noise are analyzed using the number of signals over a specific level of a tracking error pass filter, i.e., shock signals, which are supplied from a digital signal processor (DSP), and the deflection elements are detected using the deviation of the focus error levels. Accordingly, where the deviation is over a reference value, the recording speed is limited.

The fourth type includes methods of limiting the recording speed after checking the recording quality of a previous section in a zone changing section using a zone constant linear velocity (ZCLV) technique.

In the ZCLV technique, an optical disc is divided into specific zones, and the recording speed is increased toward an outer perimeter of the disc. In the case where the ZCLV technique is applied, a recording operation is stopped and restarted in a section where the zones change. Here, the recording characteristics of the previous section are monitored prior to the restart of the recording operation so that the recording speed is not increased or forcibly reduced where the monitored characteristics indicate a low recording quality.

The first through third conventional methods determine the recording speed by checking an operation before a recording operation is started, and the fourth method determines the recording speed before the recording operation is restarted. Thus, it is difficult to actively handle instability which occurs during the recording operation. In addition, the conventional methods cannot prevent a buffer under run, which is generated by the instability of wobble signals during the recording operation, and the instability of the read-in start position in a section where the ZCLV technique is applied. Therefore, such problems cause defects in the recording operation, such as over write and seek fail, and deteriorate the recording quality due to the defective wobble characteristics of poor quality media.

### SUMMARY OF THE INVENTION

Accordingly, it is an aspect of the present invention to provide an apparatus which changes a recording speed of an optical recording medium during a recording operation to minimize defects in recording quality by continuously checking wobble signals during the recording operation, and lowering or fixing the recording speed according to unstable states.

Another aspect of the present invention is to provide a method of changing a recording speed of an optical recording medium during a recording operation to minimize defects in recording quality by continuously checking wobble signals during the recording operation, and lowering or fixing the recording speed according to unstable states.

Additional aspects and advantages of the invention will be set forth in part in the description which follows and, in part, will be obvious from the description, or may be learned by practice of the invention.

To achieve the above and/or other aspects of the present invention, there is provided an apparatus for changing a recording speed of an optical recording medium, comprising a signal processing unit which outputs a cyclic redundancy check (CRC) signal that checks for a generation of errors on the optical recording medium, from absolute time in pregroove (ATIP) information which is output from the optical recording medium during a recording operation, and a speed control unit which changes the recording speed of the optical recording medium during the recording operation according to a comparison of the CRC signal output from the signal processing unit with a reference value.

The speed control unit may comprise a detection unit which detects a state of the optical recording medium from the ATIP information and the CRC signal output from the signal process unit, a comparison unit which compares a number of errors detected by the CRC signal with the reference value, and a recording speed control unit which stops the recording operation with respect to the optical recording medium where the number of errors is equal to or greater than the reference value, and changes the recording speed in a zone where the errors take place before restarting the recording operation.

The speed control unit may include a storage unit which stores data of the zone where the errors occur by checking the CRC signal.

The recording speed control unit may stop the recording operation in a section of the optical recording medium where no errors occur by checking the CRC signal.

The speed control unit may output a monitoring signal to monitor a state of control of the recording speed in real time.

To achieve the above and/or other aspects of the present invention, there is provided a method of changing a recording speed of an optical recording medium, the method comprising checking a CRC signal which checks for a generation of errors on the optical recording medium, from ATIP information which is detected from the optical recording medium during a recording operation, and stopping the recording operation with respect to the optical recording medium according to a comparison of a no good (NG) number generated by the checking of the CRC signal with a reference value, and changing the recording speed in a zone where the errors occur before restarting the recording operation.

The stopping of the recording operation and the changing of the recording speed may comprise comparing the NG number detected by the CRC signal with the reference value, stopping the recording operation with respect to the optical recording medium and storing data of a time zone where the errors occur in response to the NG number being equal to or greater than the reference value, moving to the time zone where the errors occurred and preparing to restart the recording operation, and changing the recording speed in the time zone where the errors occurred and restarting the recording operation.

In the stopping of the recording operation, the recording operation may be stopped in a section of the optical recording medium where no errors occur, by checking the CRC signal.

The method may further comprise monitoring a state of change of the recording speed in real time.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram illustrating the structure of an apparatus which changes a recording speed of an optical recording medium during a recording operation, according to an embodiment of the present invention;

FIG. 2 is a detailed diagram illustrating a control unit of FIG. 1; and

FIG. 3 is a flowchart illustrating a method of changing a recording speed of an optical recording medium during a recording operation, according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

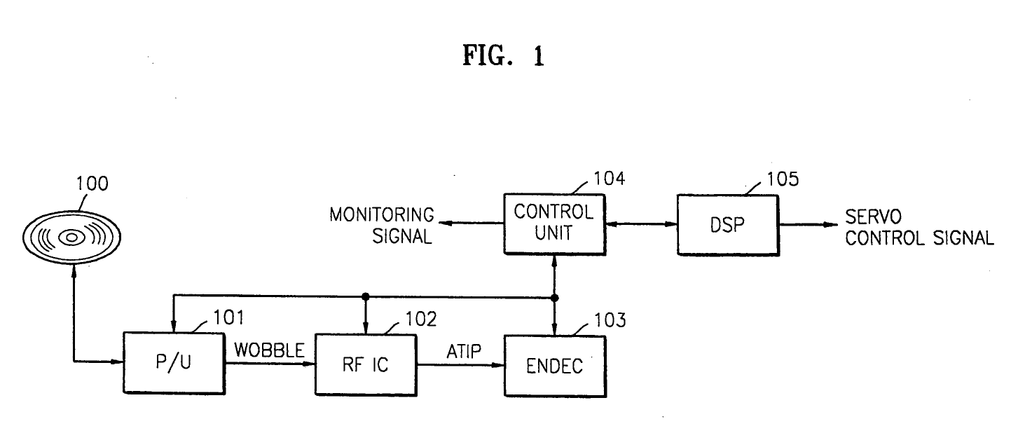

FIG. 1 shows the structure of an apparatus which changes a recording speed of an optical recording medium 100, during a recording operation, according to an embodiment of the present invention. The apparatus includes a pickup 101, a radio frequency integrated circuit (RF IC) 102, an encoder/decoder (ENDEC) 103, a control unit 104, and a digital signal processor (DSP) 105.

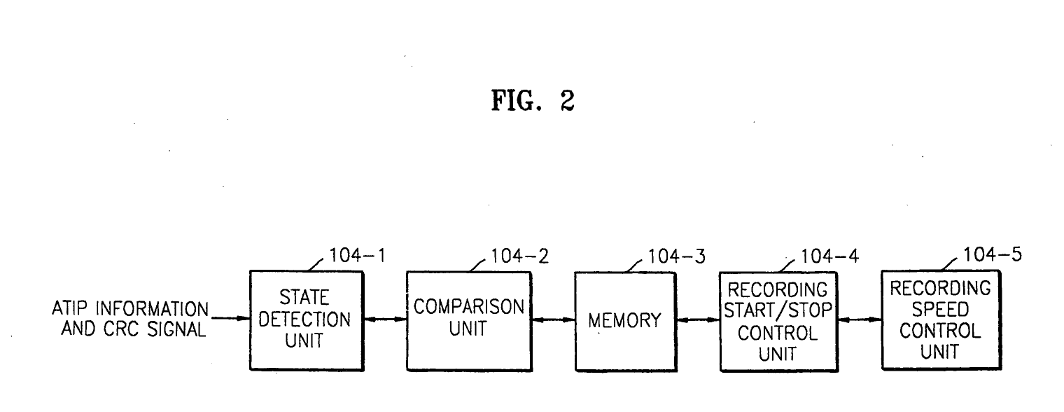

FIG. 2 shows a detailed diagram illustrating the control unit 104 of FIG. 1. The control unit 104 includes a state detection unit 104-1, a comparison unit 104-2, a memory 104-3, a recording start/stop control unit 104-4, and a recording speed control unit 104-5.

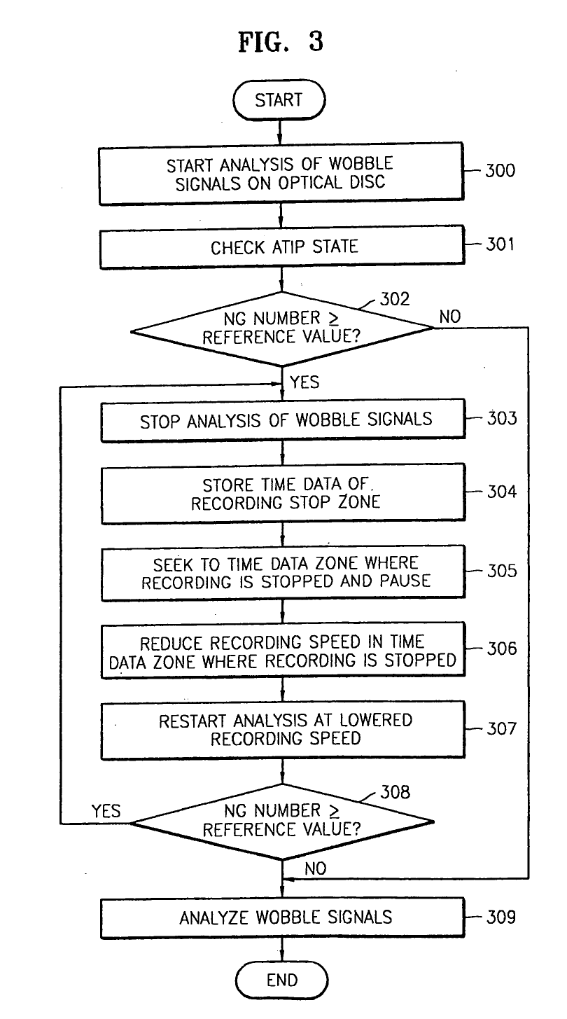

FIG. 3 shows a flowchart illustrating a method of changing a recording speed of an optical recording medium, during a recording operation, according to the present invention. Here, the method includes starting an analysis of wobble signals on the optical disc in operation 300, checking an absolute time in a pregroove (ATIP) state in operation 301, determining whether a no good (NG) number is equal to or greater than a reference value in operation 302, stopping the analysis of the wobble signals in operation 303, storing time data of a recording stop zone in operation 304, seeking the recording stop zone and pausing in operation 305, lowering the recording speed in the recording stop zone in operation 306, restarting the analysis of the wobble signals at the lowered recording speed in operation 307, determining whether the NG number is equal to or greater than the reference value in operation 308, and continuously analyzing the wobble signals in operation 309.

The present invention will now be described in detail with reference to FIGS. 1 through 3.

The pickup 101 which performs a recording operation, outputs wobble signals from the optical disc 100. Here, the wobble signals enable a reading of a disc mass storage facility (MSF), and are formed at predetermined intervals in a track direction on the optical disc 100. For example, the wobble signals are sine waves having a frequency of 22.05±1 KHz at a normal speed. By reading the wobble signals, a time code and specific data of the optical disc 100 can be read.

The analog wobble signals output from the pickup 101 are converted into ATIP signals by the RF IC 102. Accordingly, the ATIP signals can be referred to as digital wobble signals.

The ENDEC 103 encodes or decodes the ATIP signals output from the RF IC 102. In particular, the ENDED 103 stores a cyclic redundancy check (CRC) state, which is included in the ATIP signals to check for the generation of errors on the optical disc 100, in an internal register (not shown) and corrects the errors.

The DSP 105 processes servo control signals under the control of the control unit 104.

Here, the control unit 104 functions as a speed control unit and changes the speed of recording on the optical disc 100 by checking the ATIP signals output from the ENDEC 103 and the CRC state stored in the internal register. The control unit 104 monitors the state of the ATIP signals output from the ENDEC 103 to count the number of error generation sections using high bits. Thereafter, the control unit 104 determines whether to change the recording speed based on the timing and the number of counted error generation sections.

The state detection unit 104-1 checks the ATIP signals output from the ENDEC 103 and the CRC state. Here, the state detection unit 104-1 may include a counter (not shown) to count the number of errors on the optical disc 100 after the CRC state is checked. The comparison unit 104-2 compares the counted number of errors with a reference value. The recording start/stop control unit 104-4 controls the stop and restart of the recording operation, according to the comparison result of the comparison unit 104-2. In the case of stopping the recording operation due to the generation of errors, the recording operation is stopped in a zone where the errors are not generated. The recording speed control unit 104-5 changes the speed of recording on the optical disc 100 during the recording operation. The memory 104-3 stores the time data of the optical disc 100, on which the recording operation is stopped due to the generation of the errors.

To restart the recording operation, the pickup 101 seeks the zone whose time data is stored in the memory 104-3 and pauses. The recording speed control unit 104-5 changes the recording speed in the zone where the recording operation is stopped and restarts the recording operation at the changed recording speed. After the recording operation is restarted, the CRC state is continuously checked in order to maintain an optimum recording speed without generating errors.

The control unit 104 may include a separate port (not shown) to monitor the state of control of the recording speed of the optical disc 100 in real time.

Recording speed control signals are output from the control unit 104 to the pickup 101, the RF IC 102, the ENDEC 103, and the DSP 105 so that the operations of each block are controlled by the control signals.

A method of changing a recording speed, according to the present invention, will be described with reference to FIG. 3.

In operation 300, an analysis of wobble signals on the optical disc 100 is started. In operation 301, the control unit 104 checks ATIP signals output from the ENDEC 103 and the CRC state, so as to detect whether errors occur on the optical disc 100. In operation 302, the control unit 104 checks the CRC state of the optical disc 100 to determine whether an NG number is equal to or greater than a reference value.

Where the NG number is equal to or greater than the reference value, the analysis of the wobble signals is stopped in operation 303. After the analysis of the wobble signals is stopped, time data of a zone, in which the analysis of the wobble signals is stopped, is stored, in operation 304. In the case of stopping the recording operation in progress due to the generation of the errors, the recording operation is stopped in a zone on the optical disc 100 where the errors are not generated.

In operation 305, the control unit 104 seeks the zone having the time data of the stop of the recording operation and pauses, i.e., stays in a standby state, to restart the recording operation. In operation 306, the control unit 104 reduces the recording speed in the zone having the time data of the stop of the recording operation. In operation 307, the analysis of the wobble signals is restarted at a lowered recording speed.

After the analysis of the wobble signals is restarted, it is determined whether the NG number is equal to or greater than the reference value in operation 308. Where the NG number is equal to or greater than the reference value after the analysis of the wobble signals is restarted, the recording speed is continuously changed by jumping to the operation 303. Where the NG number is less than the reference value after the analysis of the wobble signals is restarted, the wobble signals are analyzed at the lowered recording speed, in operation 309.

For example, where it is assumed that errors over the reference value occur during the recording operation in a 30:24:74 zone on the optical disc 100 at a recording speed of 32 times, the recording operation is stopped in the zone where errors do not occur after the 30:24:74 zone, and the time data of the zone where the recording operation is stopped is recorded. Thereafter, the control unit 104 seeks to the zone where the recording operation is stopped and pauses and waits to restart the recording operation. The recording speed is lowered to a speed of, for example, 28 times in the zone where the recording operation was stopped and recording is restarted. After the recording operation is restarted, the CRC state is continuously checked to maintain an optimum recording speed, so as not to generate errors.

According to the present invention, a recording speed is limited or lowered where a signal quality of a recording section is less than an acceptable level during a recording operation. Accordingly, buffer under run and defects of read-in start position and seek fail, which are generated during a ZCLV operation, are prevented. In addition, the present invention detects errors in characteristics of wobble signals from low quality media, and changes the recording speed in order to improve the recording quality and readability of such discs after the recording operation.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus for changing a recording speed of an optical recording medium, the apparatus comprising:
a signal process unit which outputs a cyclic redundancy check (CRC) signal that checks for a generation of errors on the optical recording medium, from absolute time in pregroove (ATIP) information which is output from the optical recording medium during a recording operation;
a detection unit which detects a state of the optical recording medium from the ATIP information and the CRC signal output from the signal process unit, and counts the number of errors on the optical recording medium after checking the CRC signal;
a comparison unit which compares a number of errors detected by the CRC signal with the reference value;
a storage unit which stores information of a zone where the recording operation of the recording medium is stopped;
a recording start/stop control unit which, when the number of errors is at least equal to the reference value, stops recording of the optical recording medium in a zone where no errors occur, and restarts the recording operation at a lowered recording speed in the zone where the errors occur; and
a recording speed control unit which, when the recording of the optical recording medium is stopped, outputs a recording speed control signal in order to lower the recording speed in the zone where the recording operation of the recording medium is stopped and restarts the recording operation at the lowered recording speed using the recording start/stop control unit in the zone where the recording operation of the recording medium is stopped.

2. The apparatus of claim 1, wherein the recording speed control unit outputs a monitoring signal to monitor a state of control of the recording speed in real time.

3. A method of changing a recording speed of an optical recording medium, the method comprising:
checking, via a signal processing unit, a CRC signal which checks for a generation of errors on the optical recording medium, from absolute time in pregroove (ATIP) information which is detected from the optical recording medium during a recording operation;
comparing, via a detection unit in a speed control unit, the NG number detected by the CRC signal with a reference value;
stopping recording of the optical recording medium in a zone where no errors occur and storing information about a zone where recording operation of the recording medium is stopped when the number of occurrences of the errors is greater than the reference value according to a result of comparing; and
lowering the recording speed in the zone where the recording operation of the recording medium is stopped and restarting the recording operation in the zone where the recording operation of the recording medium is stopped.

4. The method of claim 3, further comprising monitoring a state of change of the recording speed in real time.

5. The apparatus of claim 1, wherein the ATIP information corresponds to a wobble signal of the optical recording medium.

6. The apparatus of claim 5, wherein the speed control unit detects errors in the wobble signal and changes the recording speed so as to improve a recording quality and reliability of the optical recording medium after the recording operation.

7. An apparatus for recording and/or reproducing data with respect to a recording medium, comprising:
a pickup which performs a recording operation on the recording medium and detects wobble signals from the recording medium;
a radio frequency integrated circuit (RF IC) which converts the wobble signals into absolute time in pregroove (ATIP) information;
an encoder/decoder (ENDEC) which encodes or decodes the ATIP information and provides a cyclic redundancy check (CRC) signal which is provided in the ATIP information, the CRC signal checking for generation of at least one error on the recording medium; and
a control unit which controls a detection unit to count the number of errors on the recording medium after checking the CRC signal, controls a comparison unit to compare the number of errors with a reference value, when the number of errors is at least equal to the reference value, controls a determining unit to stop recording of the recording medium in a zone where no errors occur, stores information about a zone where the recording operation of the recording medium is stopped, lowers the recording speed in the zone where the recording operation of the recording medium is stopped, and restarts the recording operation in the zone where the recording operation of the recording medium is stopped,
wherein the detection unit, the determining unit, and the comparison unit are separately disposed in the control unit, and
wherein a signal for lowering the recording speed is output to the pickup.

8. The apparatus of claim 7, wherein the control unit changes the recording speed by checking the ATIP information output from the ENDEC and the CRC signal.

9. The apparatus of claim 7, wherein the control unit monitors the ATIP information to count a number of error generation sections of the recording medium and changes the recording speed based on the number of counted error generation sections.

10. The apparatus of claim 7, further comprising a digital signal processor (DSP) which processes a servo control signal of the apparatus under a control of the control unit.
